(19) United States
(12) Patent Application Publication
(10) Pub. No.: US 2015/0279267 A1
(43) Pub. Date: Oct. 1, 2015

(54) PHASE LOCK LOOP BASED DISPLAY DRIVER FOR DRIVING LIGHT EMITTING DEVICE AND RELATED DISPLAY APPARATUS GENERATING INTERNAL CLOCK BASED ON EXTERNAL CLOCK

(71) Applicant: NAVIANCE SEMICONDUCTOR LIMITED, Taoyuan County (TW)

(72) Inventors: Chien-Kuo Tien, Taoyuan County (TW); Ruei-Iun Pu, New Taipei City (TW)

(73) Assignee: NAVIANCE SEMICONDUCTOR LIMITED, Taoyuan County (TW)

(21) Appl. No.: 14/228,264

(22) Filed: Mar. 28, 2014

(51) Int. Cl. G09G 3/32; H05B 33/08

(52) U.S. Cl. CPC G09G 3/32; H05B 33/0815; G09G 2310/0286; G09G 2310/08

(57) ABSTRACT

Described in example embodiments herein are techniques for reducing requirements of a driver for external high frequency clock signals. In accordance with one example embodiment, a driver for driving a light emitting device includes: a data register and a phase lock loop. The data register is utilized for storing driving data for driving the light emitting device. The phase lock loop is utilized for generating a second signal according to an input first signal. The operation of the data register is controlled according to one of the input signal and the second signal, while the driving of the light emitting device is controlled according to the other of the input signal and the second signal.

### BACKGROUND OF THE INVENTION

1. Field of the Invention

The present invention relates to driving of display device, and more particularly, to a driver, a method and a display device which can reduce requirements for external high frequency clock signals.

2. Description of the Prior Art

With rapid advancement of the technology, the display technology has been unceasingly developed and improved from the early cathode ray tube technology, to liquid crystal, plasma and light emitting diode (LED) technologies. The development of the display technologies seek for lower power consumption, greater brightness and contrast, and more accurate color rendition. In these developed technologies, the LED has self-luminous property, and hence it does not require backlight sources. Also, the LED does not suffer from the aperture ratio problem like the liquid crystal display does. Therefore, the LED display device has the advantages of higher brightness and larger display panel.

A simplified schematic diagram of a conventional LED display device is illustrated in FIG. 1. As shown by diagram, the LED display device includes a plurality of LEDs 11-MN, which are respectively driven by LED drivers 10-M0, to emit the light. The LED drivers 10-M0 provide currents to each LED, and control a respective period of providing the current to each LED. Depending on the length of the period, the LED can have different intensities. As each LED corresponds to a specific color component (e.g. R, G or B), different color components can be well-mixed by properly controlling the period of providing the current to each LED. As a result, the LED display device is able to present a full color frame.

Taking the LED driver 10 as an example, it generates a pulse time to provide currents to each of the LED11-LED1N according to a signal DIN on an input terminal DI that has driving data for LED11-LED1N. Since the signal DIN is transmitted by means of serial transmission, the signal DIN carries driving data of all LED11-LEDMN when outputted by a controller 50. The LED driver 10 merely extracts some bits out of the signal DIN, to drive LED11-LED1N, and then outputs remaining bits of the signal DIN to the following LED driver 20 through an output terminal DO. As a consequence, the LED driver 20 extracts bits corresponding to driving data for LED21-LED2N from the signal DIN, to drive the LED21-LED2N, and the rest can be done by analogy.

Please refer to FIG. 2, which illustrates a simplified block diagram of the LED driver 10 of FIG. 1. As shown by the diagram, the LED driver 10 includes: a driving unit 12, a shift register 13 and a latch 14. The shift register 13 receives and stores the signal DIN provided by the controller 50 bit by bit. The shift register 13 performs a shifting operation according to a signal DCLK provided by the controller 50. Finally, only those bits corresponding to the driving data for the LED11-LED1N is preserved. The rest of bits corresponding to the LED21-LEDMN have been fed out of the output terminal DO bit by bit. Typically, the signal DCLK is a pulse sequence (a clock signal). The shift register 13 shifts each bit in the register to the right, at rising edges or at falling edges of the pulses sequence, thereby transmitting remaining bits of the signal DIN to the shift registers of the LED drivers 20-M0.

When the bits stored in the shift register 13 exactly corresponds to the driving data for the LED11-LED1N, the controller 50 sends a signal LAT, instructing the latch 14 to extract the bits stored in the shift register 13. Then the latch 14 transmits these bits to the driving unit 12, and the driving unit 12 drives the LED11-LED1N according to these bits.

Assuming that the driving unit 12 includes N 16-bit pulse width modulation (PWM)driving units, the function of the driving unit 12 is to generate a pulse or repetitive pulses having an equivalent width (by average or by summation) identical to 1˜65535 (2¹⁶−1) units of time according to each 16-bit PWM value. According to N 16-bit PWM values stored in the latch 14 (m=N×16), the driving unit 12 respectively controls the intensity of each LED at 65536 steps. The driving unit 12 determines a period of providing the current to one LED based on the 16-bit PWM value, ranging from single unit of time to 65535 units of time. The length of the unit of the time is determined by the signal GCLK generated by the controller 50. Similar to the signal DCLK, the signal GCLK is also a pulse sequence (a clock signal), the driving unit 12 uses an interval between consecutive falling edges or consecutive rising edges of the signal GCLK as a reference period, to determine a length of the unit of time. The 16-bit PWM value is modulated based on the unit of time, thereby determining a period of providing the current to the LED.

Under such design, each LED driver has to not only receive the signal DIN from the shift register of the preceding LED driver, but also receive the signals GCLK, DCLK, and LATCH from the controller 50 in order to properly drive each LED. If the display device requires higher refresh rate, the frequency of the signal GCLK must be higher. Therefore, it is inevitable to provide external high frequency clock signals to the LED driver.

### SUMMARY OF THE INVENTION

In view of the aforementioned shortcomings of the conventional driver, the present invention provides an inventive architecture of the driver to reduce the requirements of the driver for the external high frequency clock signals (e.g. signals DCLK and GCLK). This is especially suitable for the driver for use in a display device having high refresh rate. The present invention incorporates a phase lock loop into the driver. The phase lock loop takes one clock signal (e.g. DCLK) generated by the external controller as a reference signal, and accordingly generates another clock signal (e.g. GCLK) based on the reference signal, such that the requirements for external high frequency clock signal can be reduced. Also, the number of pin counts of the driver for receiving the external high frequency clock signal is reduced. As a result, the manufacturing cost of the display device, and the complexity of the circuitry of the driver are both reduced, and electromagnetic interferences caused by transmitting the high frequency clock signal on a system board is also alleviated.

In accordance with one embodiment of the present invention, there is provided a driver for driving a light emitting device. The driver comprises a data register and a phase lock loop. The data register is arranged to store driving data for driving the light emitting device. The phase lock loop is arranged to generate a second signal according to an input signal. In addition, an operation of the data register is controlled according to one of the input signal and the second signal, and driving of the light emitting device is controlled according to the other of the input signal and the second signal.

In accordance with one embodiment of the present invention, there is provided a method for using in a driver to driving a light emitting device, wherein the driver has a phase lock loop. The method comprises: receiving an input signal; and utilizing the phase lock loop to generate a second signal according to the input signal. In addition, an operation of a data register of the driver is controlled according to one of the input signal and the second signal, and driving of the light emitting device is controlled according to the other of the input signal and the second signal, and the data register stores driving data required by driving the light emitting device.

In accordance with one embodiment of the present invention, there is provided a display device. The display device comprises a plurality of light emitting devices; a plurality of drivers and a controller. The plurality of drivers are respectively coupled to the plurality of light emitting devices, and are respectively arranged to drive the plurality of light emitting devices. The controller is arranged to provide at least an input signal to the plurality of drivers. Each driver comprises: a data register and a phase lock loop. The data register is arranged to store driving data required by driving the light emitting device. The phase lock loop is arranged to generate a second signal according to the input signal. In addition, an operation of the data register is controlled according to one of the input signal and the second signal, and driving of the light emitting device is controlled according to the other of the input signal and the second signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a simplified schematic diagram of a conventional LED display.

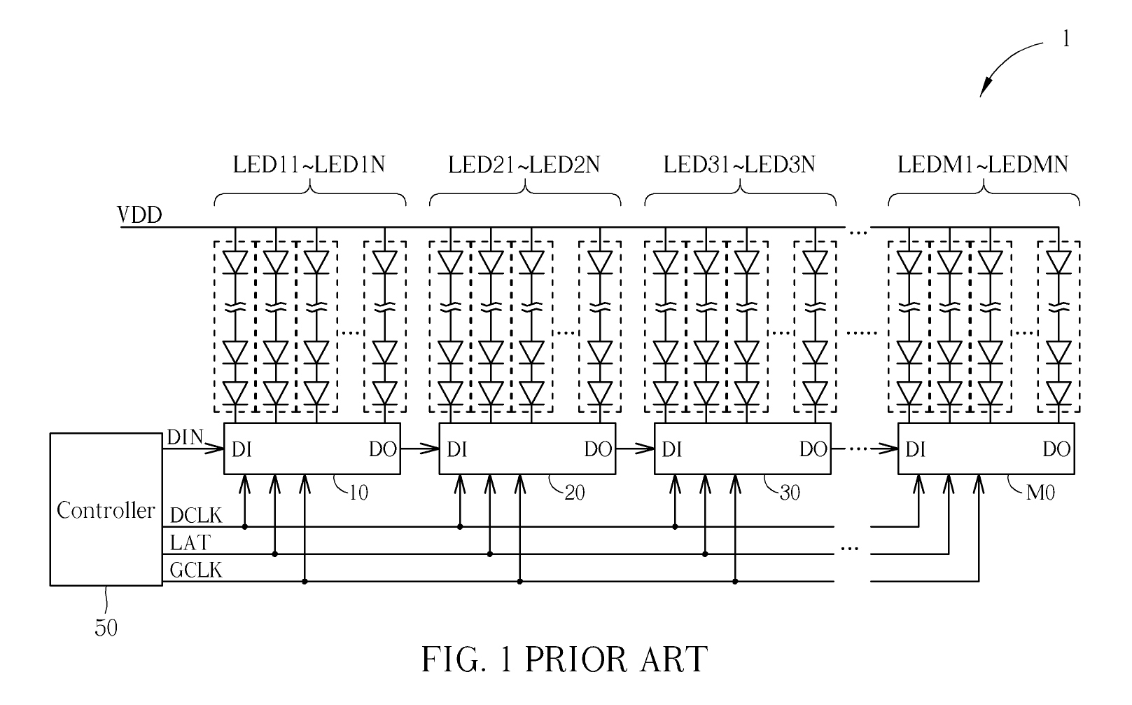

FIG. 2 illustrates a block diagram of a driver used in the LED display of FIG. 1.

FIG. 3 illustrates a block diagram of a driver according to one embodiment of the present invention.

FIG. 4 illustrates an application of combining a phase lock loop and signal processing devices within the driver according to one embodiment of the present invention.

FIG. 5 illustrates a block diagram of a driver according to another embodiment of the present invention.

FIG. 6 illustrates another application of combining a phase lock loop and signal processing devices within the driver according to one embodiment of the present invention.

FIG. 7 illustrates a schematic diagram of a display device according to one embodiment of the present invention.

FIG. 8 illustrates a flow chart of a method according to one embodiment of the present invention.

### DETAILED DESCRIPTION

Certain terms are used throughout the following descriptions and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

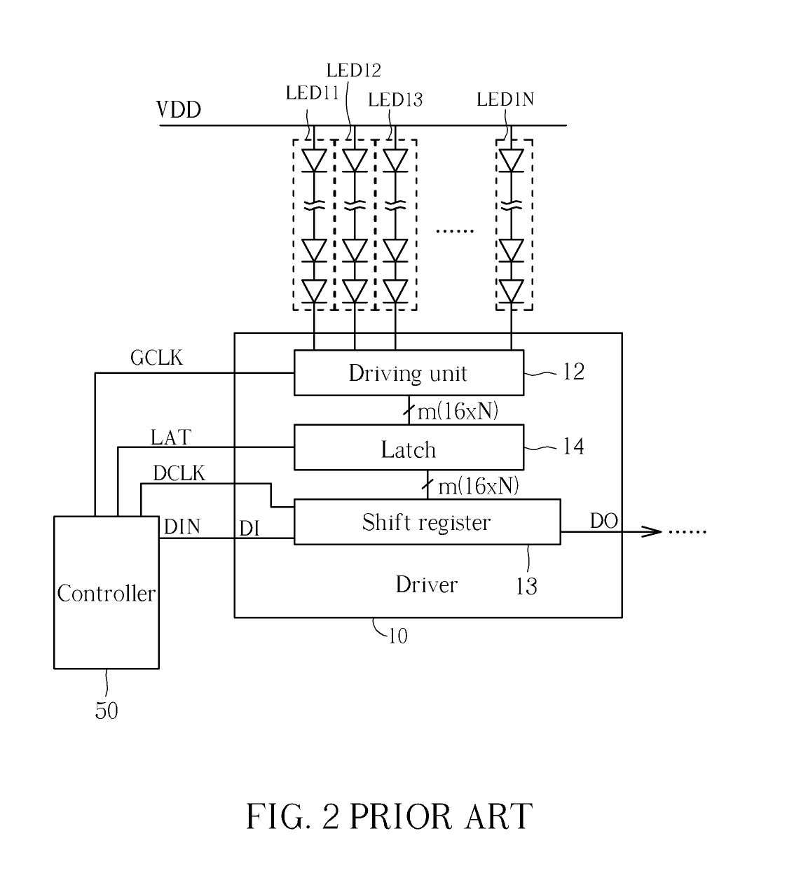

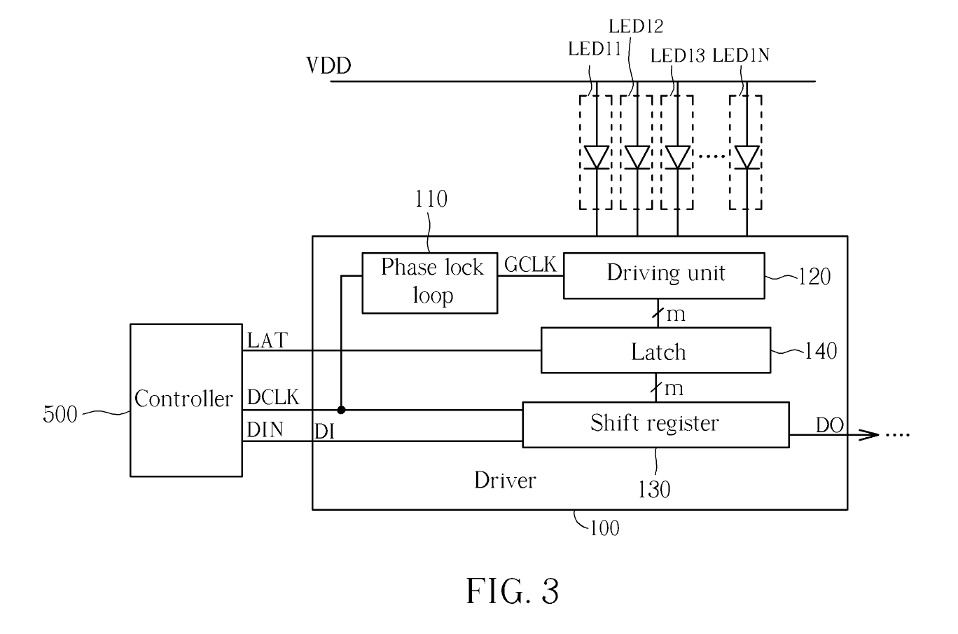

FIG. 3 illustrates a simplified schematic diagram of a driver according to one embodiment of the present invention. Compared to the conventional driver shown in FIG. 2, the driver 100 of the present invention only requires the signal DCLK, the signal LATCH and the signal DIN, but does not require the signal GCLK, which reduces the requirement for the external high frequency clock signal (i.e., the signal GCLK). The driver 100 includes a phase lock loop 110, a driving unit 120, a data register 130 and a latch 140. The driver 100 drives LED11˜LED1N in accordance with the signal DIN. It should be noted that even though there are certain quantity of LEDs illustrated in the diagram, the present invention is not limited in the quantity of LEDs. For example, in other embodiments of the present invention, the LEDs driven by the driver 100 may be arranged in an array, where an LED array includes a plurality of LED strings in parallel, and each LED string further includes a plurality of LEDs in serial.

The data register 130 receives the signal DIN provided by the controller 500, and performs shifting operations upon the signal DIN according to the signal DCLK provided by the controller 500. The data register 130 receives the signal DIN bit by bit, sends out bits in the signal DIN that corresponds to LEDs driven by other drivers (not shown) and preserves the bits in the signal DIN which corresponds to driving data for driving the LED11-LED1N. In one embodiment, the data register 130 could be a shift register. However, this is not a limitation of the present invention. Any circuit can preserve some content of the signal DIN and send remaining content to other drivers also falls within the scope of the present invention.

When bits stored in the register 130 corresponds to the driving data for driving the LED11-LED1N, the controller 500 generates the signal LAT to the driver 100, the bits stored in the data register 130 will be extracted by the latch 140, and these bits are further sent to the driving unit 120. The driving unit 120 performs the intensity control over each LED according to its PWM value (which corresponds to each LED) of the bits extracted by the latch 140. Also, according to the interval between consecutive rising edges or consecutive falling edges of the signal GLCK, or the period of the signal GCLK, a reference period can be determined. This reference period is used to determine a unit of time for providing the current to the LED, where a length of the reference period may be identical to or be directly proportional to the length of unit of time. The PWM value corresponding to the LED is modulated based on the determined unit of time, and accordingly the driver 100 controls a respective period for each LED.

In this embodiment, the signal GCLK is provided by the phase lock loop. The phase lock loop 110 uses the signal DCLK as a reference signal and performs a phase locking operation to generate the signal GCLK. With the proper design of the phase lock loop 110 (e.g. fractional-N PLL), a frequency of the signal GCLK generated by the phase lock loop 110 could be integral multiples or non-integral multiples of a frequency of the signal DCLK. Hence, even though the driver 100 does not receive the signal GCLK from the external controller, by the capability of adjusting an original frequency to integral multiples or non-integral multiples, the phase lock loop 110 can generate the signal GCLK that covers a wide frequency range, meeting the requirements of different applications (e.g. satisfying the higher refresh rate). This is because the driver 100 has to provide the intensity control of different PWM steps in different applications. Hence, the unit of time for providing the current to the LED may vary. By the capability of providing a frequency that is non-integral multiples of the original frequency, the driver 100 can derive the units of time of different lengths to meet requirements in different applications.

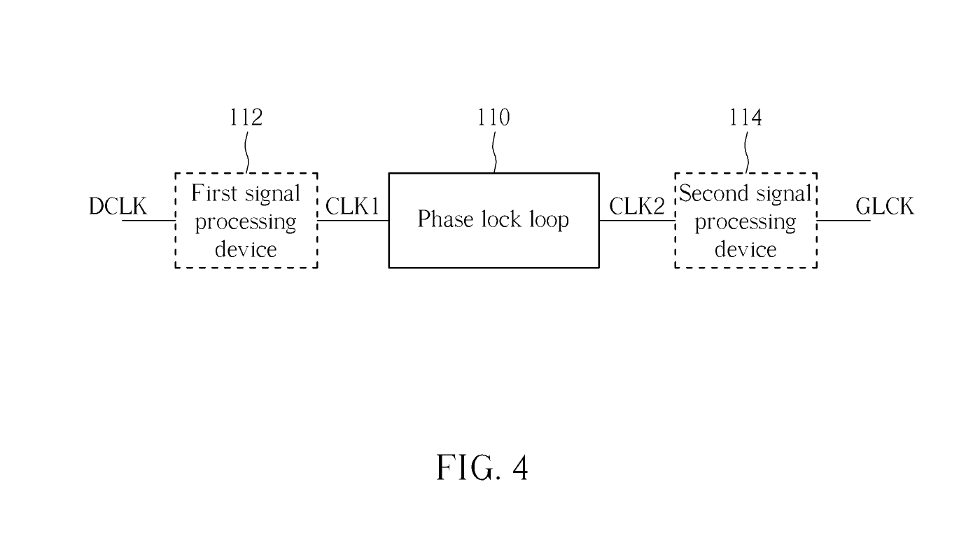

In the embodiment of FIG. 3, the phase lock loop 110 generates the signal GCLK directly according to the signal DCLK, and provides the signal GCLK to the driving unit 120 for driving the LED. However, in order to improve the coverage of frequency provided by the phase lock loop 110, additional signal processing devices are adopted in other embodiments to adjust the frequency of the signal DCLK (usually dividing the frequency by power of 2), and provides the signal having adjusted frequency to the phase lock loop 110, thereby generating the signal GCLK. Alternatively, the signal processing device may adjust the frequency of the signal generated by the phase lock loop 110 (usually dividing the frequency by power of 2), and uses the signal having adjusted frequency as the signal GCLK. Alternatively, both of them can be applied to the frequency adjustment. Such embodiment is illustrated in FIG. 4. In the embodiment shown by FIG. 4, an input terminal of the phase lock loop 110 is coupled to the first signal processing device 112. The first signal processing device 112 firstly adjusts the frequency of the signal DCLK to generate a first signal CLK1. Then, the phase lock loop 110 takes the first signal CLK1 as a reference signal for phase locking operations, and generates the second signal CLK2. The second signal processing device 114 further adjusts the frequency of the second signal CLK2 to generate the signal GCLK. Although it is described in the above embodiment that both of the signal processing devices 112 and 114 are used to process frequencies of signals that are sent into and out from the phase lock loop 110, this is not a limitation, however. In other embodiments of the present invention, there may be only one of the first signal processing device 112 and the second signal processing device 114 included in the driver 100 for the frequency adjustment.

In one embodiment of the present invention, the first signal processing device 112 and the second signal processing device 114 may be frequency dividers dividing the frequency by the power of 2. The relationship between frequencies of signals of FIG. 4 can be expressed as below:

fCLK2=(fDCLK/2^{K})×Q;

fGCLK=fCLK2/2^{L};

fCLK2=fCLK1×Q;

(where K, L are positive integers, Q is an integer that is greater than one or equal to one or a non-integer that is greater than one, fCLK1 is the frequency of the signal CLK1, fCLK2 is the frequency of the signal CLK2, fDCLK is the frequency of the signal DCLK and fGCLK is the frequency of the signal GCLK). From the above equations, with proper parameters, the phase lock loop 100 can provide a clock signal having a variety of possible frequencies by taking the advantage of the first signal processing device 112 and/or the second signal processing device 114. Hence, the frequency of the signal GCLK can be precisely determined by the driver 100 depending on requirements of different applications.

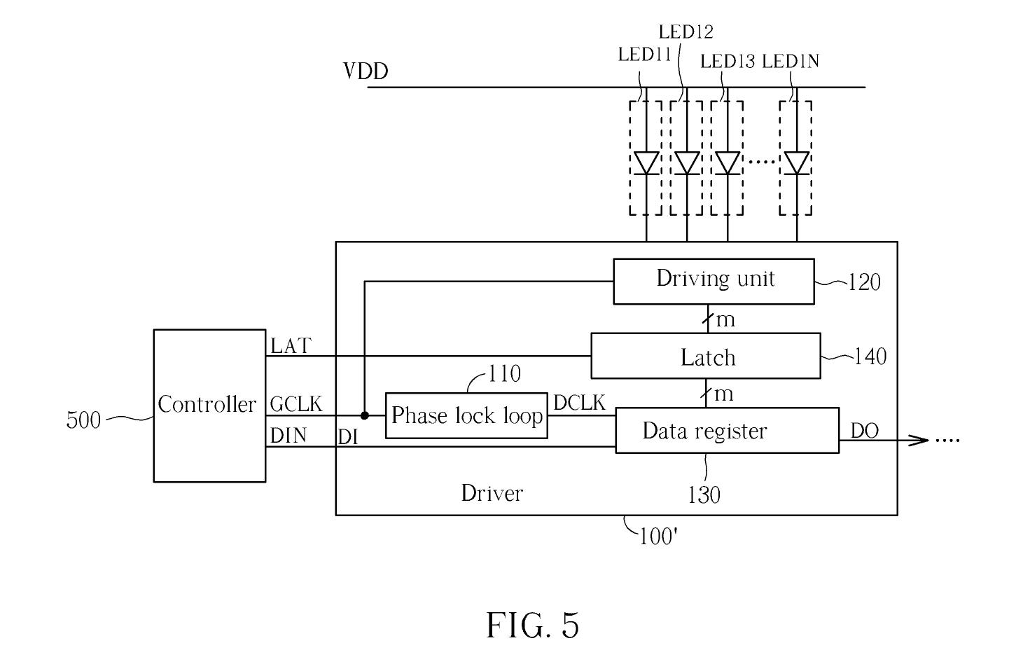

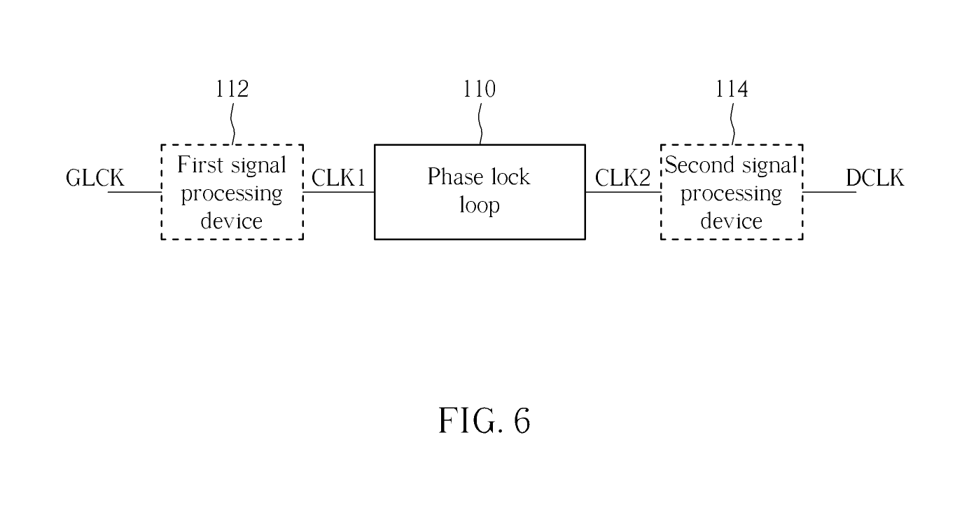

In the above descriptions, the phase lock loop 110 or the first signal processing device 112 as well as the second signal processing device 114 generates the signal GCLK based on the signal DCLK. However, it is also available to generate the signal DCLK based on the signal GCLK in various embodiments of the present invention. Please refer to an embodiment illustrated by FIG. 5 and FIG. 6. In this embodiment, the phase lock loop 110 of the driver 100′ generates the signal DCLK according to the signal GCLK provided by the controller 500. The driving unit 120 drives the LEDs based on the signal GCLK provided by the controller 500, and the data register 130 performs shifting operations upon the signal DIN based on the signal DCLK generated by the phase lock loop 110. The additional signal processing device may be used to adjust the frequency of the signal DCLK in advance and accordingly sends a signal having adjusted frequency to the phase lock loop 110, thereby generating the signal DCLK. Alternatively, the additional signal processing device may adjust the frequency of the signal generated by the phase lock loop 110, and generates a signal having adjusted frequency as the signal DCLK (usually dividing the original frequency by power of 2). Alternative, both of them can be applied.

The relationship between the frequencies of the signals illustrated in FIG. 6 can be expressed as below:

fCLK2=(fGCLK/2^{K})×Q;

fDCLK=fCLK2/2^{L};

fCLK2=fCLK1×Q;

(where K, L are positive integers, Q is an integer that is greater than one or equal to one or a non-integer that is greater than one, fCLK1 is the frequency of the signal CLK1, fCLK2 is the frequency of the signal CLK2, fDCLK is the frequency of the signal DCLK and fGCLK is the frequency of the signal GCLK).

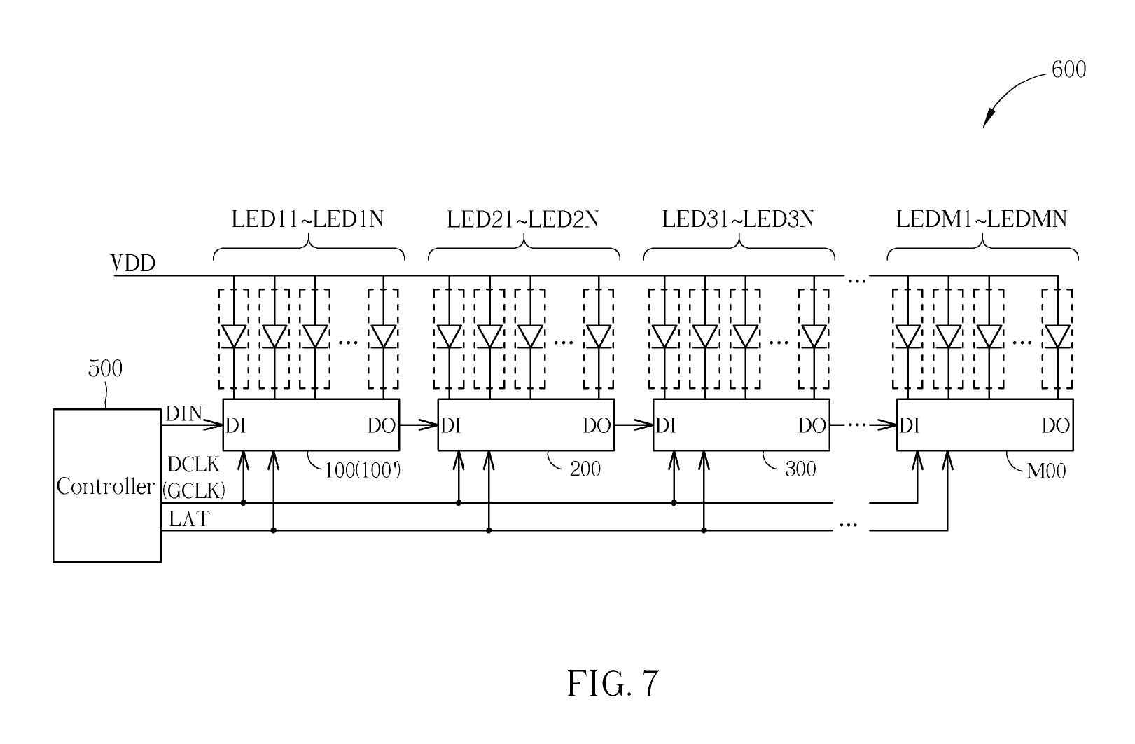

FIG. 7 illustrates an LED display device 600 based on the driver 100 shown in FIG. 3 or the driver 100′ shown in FIG. 5. As shown in FIG. 7, the LED display device 600 includes a plurality of light emitting devices LED11-LEDMN, and the light emitting devices LED11-LEDMN are respectively driven by the drivers 100-M00. The controller 500 provides at least the signal DIN, the signal LAT and the signal DCLK (or the signal GCLK) to the drivers 100-M00. The architecture of each of the drivers 100-M00 may be equivalent to the driver 100 of FIG. 3 or the driver 100′ of FIG. 5. Each driver further includes data register and phase lock loop. As the principles of the driver have been expressly explained in the above, these descriptions are not repeated here for the sake of brevity. Please note that the quantity of the LEDs and the quantity of the drivers are not limitations of the present invention. In addition, the types and the quantity of the control signals provided by the controller 500 are not limitations of the present invention. In other embodiments, the controller 500 may further provide additional control signals for controlling the operations of the drivers 100-M00.

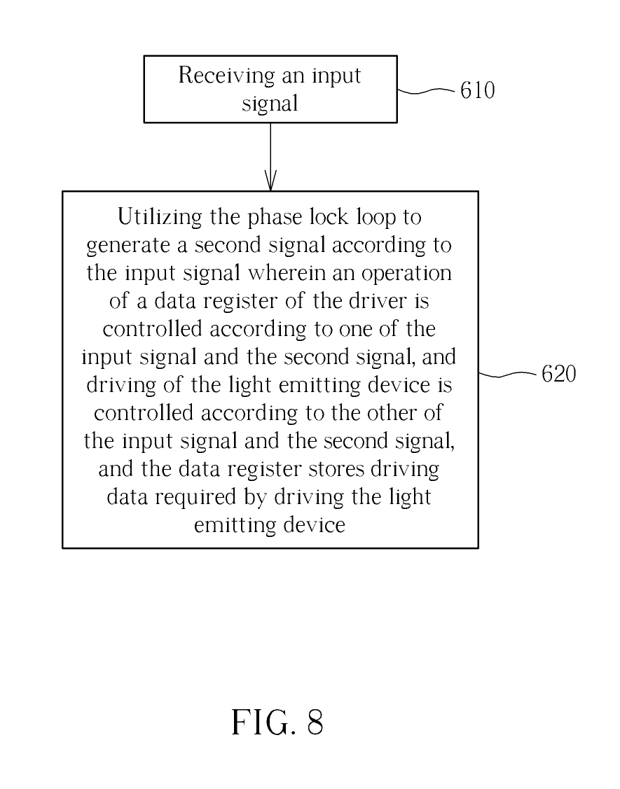

According to one embodiment, a method for use in a driver to drive a light emitting device is provided. The driver includes a phase lock loop, and the method includes step 610 and step 620 illustrated in FIG. 8. In step 610, an input signal is received. In step 620, a phase lock loop is utilized to generate a second signal based on the input signal. The phase lock loop performs a phase locking operation based on the input signal to generate the second signal. In one embodiment, the input signal could be directly referred to by the phase lock loop to generate the second signal, and in another embodiment, a frequency adjustment operation may be performed upon the input signal to generate a first signal, and the phase lock loop refers to the first signal to perform the phase locking operation to generate the second signal. In addition, one of the input signal and the first signal could be used to control an operation of a data register of the driver, while the second signal could be used to determine a unit of time required by driving the light emitting device, wherein the data register stores a driving data for driving the light emitting device. Alternatively, it is also possible that one of the input signal and the first signal is used to determine the unit of time required by driving the light emitting device, while the second signal is used to control the operation of the data register of the driver.

Furthermore, after step 620, it is possible to perform a frequency adjustment operation upon the second signal to generate an output signal. Therefore, in one embodiment, the input signal could be used to control the operation of the data register of the driver, while one of the second signal and the output signal could be used to determine the unit of time required by driving the light emitting device. Alternatively, it is also possible that the input signal is used to determine the unit of time required by driving the light emitting device, while one of the second signal and the output signal is used to control the operation of the data register of the driver. Alternatively, it is possible that one of the input signal and the output signal is used to determine the unit of time required by driving the light emitting device, while the other of the input signal and the output signal is used to control the operation of the data register of the driver.

According to various embodiments of the present invention, the input signal, the first signal, the second signal and the output signal are pulse sequences/clock signals. The rising edges or failing edges of any of these signals can be used to trigger a shifting operation of the data register. Also, the interval between consecutive rising edges or failing edges of any of these signals can be used as a reference period. The unit of time may be equivalent to the reference period or be directly proportional to the reference period. The driving data is then modulated based on the unit of time to determine the period of providing the current to the light emitting device.

Although the driver in the aforementioned embodiments is described as driving the LED, and the display device is described as an LED display device, this is not limitations of the present invention, however. Actually, the driver of the present invention can be also used to drive any other types of light emitting devices. In addition, the display device of the present can be also implemented with any other types of display units. These modifications still fall within the scope of the present invention.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment. Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

In summary, the present invention reduces the requirements of the driver for external high frequency clock signals by utilizing the phase lock loop. In addition, with the frequency adjustment provided by the signal processing device, the clock signal generated inside the driver is able to cover a wide frequency range, such that the driving of the light emitting device and the operation of the data register can be precisely controlled.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driver for driving a light emitting device, comprising:
a data register, arranged to store driving data required by driving the light emitting device; and
a phase lock loop, arranged to generate a second signal according to an input signal;
wherein an operation of the data register is controlled according to one of the input signal and the second signal, and driving of the light emitting device is controlled according to the other of the input signal and the second signal.

2. The driver of claim 1, wherein a frequency of the second signal is greater than or equal to a frequency of the input signal.

3. The driver of claim 1, further comprising:
a first signal processing device, coupled to an input terminal of the phase lock loop, arranged to adjust a frequency of the input signal to generate a first signal, and provide the first signal to the phase lock loop for generating the second signal.

4. The driver of claim 3, wherein the first signal processing device is a frequency divider, and a frequency of the first signal is a fraction of the frequency of the input signal.

5. The driver of claim 3, wherein one of the first signal and the input signal is utilized to control a shifting operation of the data register, and the second signal is utilized to control a reference period required by driving the light emitting device.

6. The driver of claim 3, wherein one of the first signal and the input signal is utilized to control a reference period required by driving the light emitting device, and the second signal is utilized to control a shifting operation of the data register.

7. The driver of claim 1, further comprising:
a second signal processing device, coupled to an output terminal of the phase lock loop, arranged to adjust a frequency of the second signal to generate an output signal.

8. The driver of claim 7, wherein the second signal processing device is a frequency divider and a frequency of the output signal is a fraction of the frequency of the second signal.

9. The driver of claim 7, wherein the input signal is utilized to control a shifting operation of the data register, and one of the second signal and the output signal is utilized to control a reference period required by driving the light emitting device.

10. The driver of claim 7, wherein the input signal is utilized to control a reference period required by driving the light emitting device, and one of the second signal and the output signal is utilized to control a shifting operation of the data register.

11. A method for use in a driver to drive a light emitting device, the driver having a phase lock loop, the method comprising:
receiving an input signal; and
utilizing the phase lock loop to generate a second signal according to the input signal;
wherein an operation of a data register of the driver is controlled according to one of the input signal and the second signal, and driving of the light emitting device is controlled according to the other of the input signal and the second signal, and the data register stores driving data required by driving the light emitting device.

12. The method of claim 11, wherein a frequency of the second signal is greater than or equal to a frequency of the input signal.

13. The method of claim 11, further comprising:
adjusting a frequency of the input signal to generate a first signal; and
utilizing the phase lock loop to generate the second signal according to the first signal.

14. The method of claim 13, wherein the step of adjusting the frequency of the input signal comprises:
performing a frequency-dividing operation upon the input signal to generate the first signal, wherein a frequency of the first signal is a fraction of the frequency of the input signal.

15. The method of claim 13, further comprising:
utilizing one of the first signal and the input signal to control a shifting operation of the data register; and
utilizing the second signal to control a reference period required by driving the light emitting device.

16. The method of claim 13, further comprising:
utilizing one of the first signal and the input signal to control a reference period required by driving the light emitting device; and
utilizing the second signal to control a shifting operation of the data register.

17. The method of claim 11, further comprising:
adjusting a frequency of the second signal to generate an output signal.

18. The method of claim 17, wherein the step of adjusting the frequency of the second signal comprises:
performing a frequency-dividing operation upon the second signal to generate the output signal, wherein a frequency of the second signal is a fraction of the frequency of the output signal.

19. The method of claim 17, further comprising:
utilizing the input signal to control a shifting operation of the data register; and
utilizing one of the second signal and the output signal to control a reference period required by driving the light emitting device.

20. The method of claim 17, further comprising:
utilizing the input signal to control a reference period required by driving the light emitting device; and
utilizing one of the second signal and the output signal to control a shifting operation of the data register.

21. A display device, comprising:
a plurality of light emitting devices;
a plurality of drivers, respectively coupled to the plurality of light emitting devices, respectively arranged to drive the plurality of light emitting devices; and
a controller, arranged to provide at least an input signal to the plurality of drivers;
wherein each driver comprises:
a data register, arranged to store driving data required by driving the light emitting device; and
a phase lock loop, arranged to generate a second signal according to the input signal;
wherein an operation of the data register is controlled according to one of the input signal and the second signal, and driving of the light emitting device is controlled according to the other of the input signal and the second signal.

22. The display device of claim 21, wherein a frequency of the second signal is greater than or equal to a frequency of the input signal.

23. The display device of claim 21, wherein each driver further comprises:
a first signal processing device, coupled to an input terminal of the phase lock loop, arranged to adjust a frequency of the input signal to generate a first signal, and provide the first signal to the phase lock loop for generating the second signal.

24. The display device of claim 23, wherein the first signal processing device is a frequency divider, and a frequency of the first signal is a fraction of the frequency of the input signal.

25. The display device of claim 23, wherein one of the first signal and the input signal is utilized to control a shifting operation of the data register, and the second signal is utilized to control a reference period required by driving the light emitting device.

26. The display device of claim 23, wherein one of the first signal and the input signal is utilized to control a reference period required by driving the light emitting device, and the second signal is utilized to control a shifting operation of the data register.

27. The display device of claim 21, wherein each driver comprises:
a second signal processing device, coupled to an output terminal of the phase lock loop, arranged to adjust a frequency of the second signal to generate an output signal.

28. The display device of claim 27, wherein the second signal processing device is a frequency divider and a frequency of the output signal is a fraction of the frequency of the second signal.

29. The display device of claim 27, wherein the input signal is utilized to control a shifting operation of the data register, and one of the second signal and the output signal is utilized to control a reference period required by driving the light emitting device.

30. The display device of claim 27, wherein the input signal is utilized to control a reference period required by driving the light emitting device, and one of the second signal and the output signal is utilized to control a shifting operation of the data register.
